(19) United States
(12) Patent Application Publication
(10) Pub. No.: US 2024/0418908 A1
(43) Pub. Date: Dec. 19, 2024

(54) FILTER LENS AND METHOD FOR PREPARING THE SAME

(71) Applicant: PLATINUM OPTICS TECHNOLOGY INC., Taoyuan City (TW)

(72) Inventors: Shih-Song Cheng, Taoyuan City (TW); Bo-Xun Zhu, Taoyuan City (TW); Jia-Cheng Chang, Taoyuan City (TW); Kuan-Yu Chen, Taoyuan City (TW); Hung-Han Duan, Taoyuan City (TW); Shi-Lin Zhang, Taoyuan City (TW); Chin-Lung Chen, Taoyuan City (TW)

(73) Assignee: PLATINUM OPTICS TECHNOLOGY INC., Taoyuan City (TW)

(21) Appl. No.: 18/743,934

(22) Filed: Jun. 14, 2024

(30) Foreign Application Priority Data
Jun. 16, 2023 (TW) 112122738

(51) Int. Cl. G02B 3/00; C08J 7/04; C08K 5/00; C09K 11/06; G02B 1/04; G02B 5/20

(52) U.S. Cl. CPC G02B 3/00; C08J 7/0427; C08K 5/0041; C09K 11/06; G02B 1/041; G02B 5/208; C08J 2333/12; C09K 2211/188; G02B 2003/0093

(57) ABSTRACT

Provided is a filter lens and a method for preparing the filter lens. The filter lens includes a copper complex, wherein the copper complex is formed from a copper compound providing copper ions, phosphoric acid represented by formula 1 herein, and at least one phosphorus-containing compound represented by formulas 2 to 4 herein, wherein the OD value of the filter lens for the incident light wavelength of 930 nm to 950 nm is greater than 4. The present disclosure enables a filter lens to have the function of filtering out near-infrared instead of using a traditional filter component and thus the size of the assembled optical lens module is reduced. The filter lens can further filter out light having other specific wavelengths, and thereby the number of lenses in the assembled optical lens module is reduced.

### CROSS-REFERENCE TO RELATED APPLICATION

This application claims the benefit of priority of Taiwan Patent Application No. 112122738, filed Jun. 16, 2023, the entire contents of which are hereby incorporated by reference.

### BACKGROUND

### Technical Field

The present disclosure relates to a filter lens; more particularly, to a filter lens having the function of near-infrared absorption.

### Description of Associated Art

A well-known optical camera lens module mainly comprises components, such as a lens group, a filter, a photosensitive element, etc., among which a photosensitive element can be designed to sense lights at different wavelengths and thus to find various applications, for example, to sense infrared rays (for 3D sensing), visible light (for a general camera or a video camera), ultraviolet rays (for a lidar lens of a self-driving car) and X rays (for a digital X ray machine without films).

For the application in a general camera or a video camera, a photosensitive element primarily sense in the range of visible light and a part of near-infrared rays; however, it is desirable to sense visible light only since near-infrared rays are considered as interference on images. Previously, a separate external filter having a high absorbance for near-infrared rays and a high transmittance for light at other wavelengths is typically disposed on the incident side in an optical camera lens module, thereby achieving the purpose of filtering near-infrared rays out. However, the use of an external filter to filter out near-infrared rays may result in an oversized optical camera lens module due to the space for the external filters.

In addition, as the number of lenses in the lens group increases for functionality and image quality, the problem of the optical camera lens module being oversized is further exacerbated, to accommodate these lenses.

Inability to reduce the size of the optical camera lens module has led to a common problem of the camera lens protruding outward in mobile phones, even for high-end mobile phones, which increases the risk of collision, damage, and the like. Moreover, it cannot meet the market expectations for the tendency of miniaturization and thinness of components.

### SUMMARY

Given the problems mentioned above, the present disclosure provides a filter lens, comprising:
a copper complex which is formed by a copper compound providing copper ions, a phosphonic acid represented by Formula 1, and at least one phosphor-containing compound represented by Formulas 2 to 4,

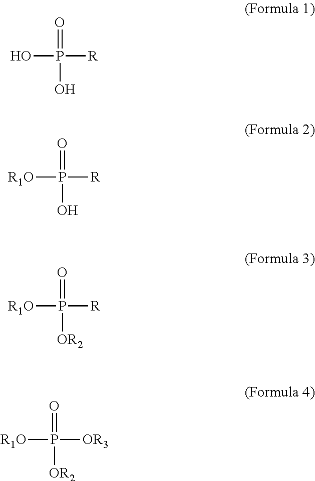

wherein R, R₁, R₂ and R₃ are each independently substituted or unsubstituted C₁-C₁₂ alkyl or substituted or unsubstituted C₆-C₁₂ aryl;
wherein the OD value of the filter lens for the incident light wavelength of 930 nm to 950 nm is greater than 4.

In an embodiment, the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

In an embodiment, the filter lens has a haze of 0.4% or less.

In an embodiment, an X-ray photoelectron spectroscopy spectrum of the filter lens has at least one principal peak at binding energy of 930-940 eV. In a further embodiment, the at least one principal peak in the X-ray photoelectron spectroscopy spectrum of the filter lens has counts per second of 4500 or more.

In an embodiment, the filter lens has a thickness of 25-150 μm.

In an embodiment, the filter lens further comprises an optical resin. In a further embodiment, the optical resin is a thermoplastic resin and/or a photocurable resin. In a further embodiment, the optical resin is selected from polycarbonates, polyesters, polycycloolefins, polyacrylics, siloxane resins and polyimides. In a further embodiment, the optical resin is methyl methacrylate.

In an embodiment, the filter lens further comprises a near-infrared absorption dye and/or an ultraviolet absorption dye.

In an embodiment, the filter lens is a convex lens, a concave lens, or a flat lens. In a further embodiment, the filter lens is a convex lens and further comprises a near-infrared absorption dye. In a further embodiment, the filter lens is a concave lens and further comprises an ultraviolet absorption dye.

In an embodiment, for an incident light wavelength range of 460 nm to 560 nm, the filter lens has a minimum transmittance of 80% or more. In a further embodiment, for the incident light wavelength range of 460 nm to 560 nm, the filter lens has a minimum transmittance of 85% or more.

In an embodiment, for an incident light wavelength range of 830 nm to 1200 nm, the filter lens has a maximum transmittance of 1% or less. In a further embodiment, for the incident light wavelength range of 830 nm to 1200 nm, the filter lens has a maximum transmittance of 0.5% or less.

In an embodiment, the OD value of the filter lens for the incident light wavelength range of 930 nm to 950 nm is greater than 4.5.

In an embodiment, the filter lens has a passband overlaid with the wavelength range of 350 nm to 850 nm, and the central wavelength of the passband is in the wavelength range of 350 nm to 850 nm.

The present disclosure further provides a method for preparing a filter lens, comprising:
providing a copper compound, a phosphonic acid represented by Formula 1, and at least one phosphor-containing compound represented by Formulas 2 to 4, to form a composition containing a copper complex,

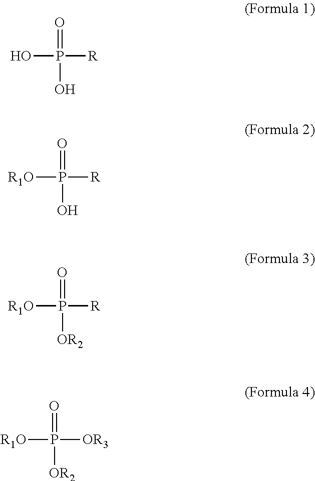

wherein R, R₁, R₂ and R₃ are each independently substituted or unsubstituted C₁-C₁₂ alkyl or C₆-C₁₂ aryl; and
curing the composition to obtain the filter lens,
wherein the OD value of the filter lens for the incident light wavelength of 930 nm to 950 nm is greater than 4.

In an embodiment, the curing step comprises loading the composition into a die for curing-forming to obtain the filter lens.

In an embodiment, the curing step comprises coating the composition on a substrate and patterning the mixture using a lithography process to obtain the filter lens.

In an embodiment, the curing-forming is carried out via injection molding, thermoforming, vacuum forming, or photocuring.

In an embodiment, the curing-forming is performed for 1 hr or less.

In an embodiment, the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

In an embodiment, the filter lens has a haze of 0.4% or less.

In an embodiment, an X-ray photoelectron spectroscopy spectrum of the filter lens has at least one principal peak at binding energy of 930-940 eV. In a further embodiment, the at least one principal peak in the X-ray photoelectron spectroscopy spectrum of the filter lens has counts per second of 4500 or more.

In an embodiment, the filter lens has a thickness of 25-150 μm.

In an embodiment, the filter lens further comprises an optical resin. In a further embodiment, the optical resin is a thermoplastic resin and/or a photocurable resin. In a further embodiment, the optical resin is selected from polycarbonates, polyesters, polycycloolefins, polyacrylics, siloxane resins and polyimides. In a further embodiment, the optical resin is methyl methacrylate.

The present disclosure firstly prepares a composition for forming a lens, which is capable of effectively absorbing incident light at a wavelength of 800-1000 nm, particularly absorbing incident light at the wavelength of 940 nm excellently, while has a very high transmittance for visible light, and the composition comprises a copper complex mainly contributing the near-infrared absorption. Thus, the lens of the present disclosure has the function of filtering near-infrared ray out, thereby reducing the finished product size of the assembled optical camera lens module due to the exclusion of the use of additional filter components. Further, other additives that have the effect of reducing the transmittance of certain wavelengths, such as a near-infrared absorption dye, an ultraviolet absorption dye, etc., can be added to the lens, thereby allowing the lens to further filter light at a certain wavelength, decreasing the number of lens needed, and reducing the product size of the assembled optical camera lens module.

### BRIEF DESCRIPTION OF THE DRAWINGS

FIG. 1 is a side view of the schematic diagram of an exemplary filter lens of the present disclosure.

FIG. 2 is a schematic diagram showing a process of a method for preparing an exemplary filter lens of the present disclosure.

FIGS. 3-5 are schematic diagrams showing a processes of another method for preparing an exemplary filter lens of the present disclosure.

FIG. 6 is the X-ray photoelectron spectroscopy spectrum of the near-infrared absorption layer in Preparation Example 1.

### DETAILED DESCRIPTION

The following describes the implementation of the present disclosure through specific embodiments, a person having ordinary skill in the art can easily understand the scope and effect of the present disclosure based on the content recorded herein.

It should be noted that the structures, proportions, sizes, etc. shown in the drawings attached to this specification are only used to exemplify the content disclosed in the specification for the understanding and reading of people skilled in this art, and are not intended to limit the scope of the present disclosure. The present disclosure may also be implemented or applied as described in the various examples. It is also possible to modify or alter the following examples for carrying out the present disclosure without violating its spirit and scope, for different aspects and applications. One of skill in the art will appreciate that structural modifications, changes in proportions, or adjustments in size of the disclosed embodiments will fall within the scope of the technical content disclosed in the present disclosure without affecting the effects that can be produced and the purposes that can be achieved by the present disclosure.

Meanwhile, terms such as “upper”, “first” and “second” recited in the specification are also used for clear description but not for defining the scope capable of being implemented by the present disclosure, the change or adjustment of their relative relationship without substantial alteration of the technical contents are also considered within the implementation scope of the present disclosure.

Unless stated otherwise, “comprising”, “containing” or “having” particular elements used herein means that other elements such as units, components, structures, regions, parts, devices, systems, steps and connection relationships can be also included rather than excluded.

Unless expressly stated otherwise, the singular forms “a”, “an” and “the” also include the plural forms, and the “or” and “and/or” can be used interchangeably herein.

The numeric ranges described herein are inclusive and combinable, and any value falling into the numeric ranges described herein can be used as the upper or lower limit to derive a subrange. For example, a numeric range of “25-200” should be understood to include any subranges between the endpoints 25 and 200, e.g., subranges of 25-150, 30-200, 30-150, etc. In addition, a value falling into each range described herein (e.g., between the upper and lower limits) should be considered to be included in the range described herein.

The first aspect of the present disclosure is a filter lens, comprising: a copper complex which is formed by a copper compound providing copper ions, a phosphonic acid represented by Formula 1, and at least one phosphor-containing compound represented by Formulas 2 to 4,

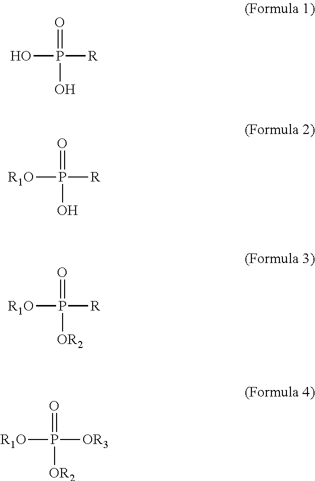

wherein R, R₁, R₂ and R₃ are each independently substituted or unsubstituted C₁-C₁₂ alkyl or C₆-C₁₂ aryl.

The copper complex can be presented by formula Cu²⁺X, wherein Cu²⁺ is provided by a copper compound; and X can be contributed by a phosphonic acid and/or a phosphorus-containing compound.

The alkyl includes, but not limited to, methyl, ethyl, n-propyl, iso-propyl, n-butyl, sec-butyl, iso-butyl, tert-butyl, pentyl, etc., and examples of the substituted alkyl includes, but not limited to, haloalkyl, hydroxyalkyl, nitroalkykl, alkoxyalkyl, etc. The aryl includes, but not limited to, phenyl, nathphyl, etc., and examples of the substituted aryl includes, but not limited to haloaryl (e.g., chorophenyl), nitroaryl, hydroxyaryl, alkoxyaryl, haloalkylaryl, nitroalkylaryl, hydroxyalkylarykl.

In an embodiment, the phosphonic acid is butylphosphonic acid.

The copper compound is used mainly as a supply source of copper ions, and well known copper compounds may be employed to provide copper ions, such as copper salts, e.g., copper acetate or copper acetate hydrate, as well as anhydrides or hydrates of copper chloride, copper formate, copper stearate, copper benzoate, copper pyrophosphate, copper naphthenate, and copper citrate. In an embodiment, the copper compound for providing copper ions is copper acetate.

The phosphorus-containing compound has the function of dispersion to make the components (including the copper complex formed) achieve uniform dispersing without agglutinating with each other. One effect of this function is to make a microcrystal size therein to be between 5 nm and 80 nm, or between 20 nm and 60 nm, e.g., 5, 10, 15, 20, 25, 30, 35, 40, 45, 50, 60, 70, 80, 90 and 100 nm. Sufficient near-infrared absorption property can be exhibited at a microcrystal size of 5 nm or more; while the product prepared has a relatively low haze due to the small number average particle size when the microcrystal size is 100 nm or less.

The copper complex can be prepared from a near-infrared absorption composition which comprises the copper compound, the phosphonic acid and the phosphorus-containing compound, and each component reacts with each other to form the copper complex. In the present disclosure, the proportion of each component can be adjusted as needed, for example, in the near-infrared absorption composition, the copper compound for providing copper ions may be of 1-150 weight parts, such as 1, 5, 10, 15, 20, 25, 30, 35, 40, 45, 50, 55, 60, 65, 70, 75, 80, 85, 90, 95, 100, 105, 110, 115, 120, 125, 130, 135, 140, 145 or 150 weight parts; the phosphonic acid may be of 1-100 weight parts, such as 1, 5, 10, 15, 20, 25, 30, 35, 40, 45, 50, 55, 60, 65, 70, 75, 80, 85, 90, 95 or 100 weight parts; and the phosphorus-containing compounds may be of 1-90 weight parts in total, such as 1, 5, 10, 15, 20, 25, 30 35, 40, 45, 50, 55, 60, 65, 70, 75, 80, 85 or 90 weight parts.

In an embodiment, the near-infrared absorption composition comprises the phosphorus-containing compounds represented by Formulas 2 to 4 concurrently with the proportions can be adjusted as needed, for example, in the near-infrared absorption composition, the phosphorus-containing compound represented by Formula 2 may be of 1-90 weight parts, the phosphorus-containing compound represented by Formula 3 may be of 1-90 weight parts the phosphorus-containing compound represented by Formula 4 may be of 1-90 weight parts, wherein the phosphorus-containing compounds represented by Formulas 2 to 4 each may be, for example, of 1, 5, 10, 15, 20, 25, 30, 35, 40, 45, 50, 55, 60, 65, 70, 75, 80, 85 or 90 weight parts. In a further embodiment, the ratio of the phosphorus-containing compound represented by Formula 2: the phosphorus-containing compound represented by Formula 3: the phosphorus-containing compound represented by Formula 4 is 20:20:50.

In an embodiment, the near-infrared absorption composition may be the form of a dispersion, i.e., the near-infrared absorption composition further comprises a solvent in addition to the copper compound, the phosphonic acid and the phosphorus-containing compound. During formulation, the copper compound, the phosphonic acid and the phosphorus-containing compound may be added into the solvent and mixed, the ratio of those components to the solvent may be 1:5 to 1:1, such as 1:3, but not limited thereto.

The solvent may be selected from well-known solvents, including but not limited to, water, alcohols, ketones, ethers, esters, aromatic hydrocarbons, halogenated hydrocarbons, dimethylformamide, dimethylacetamide, dimethyl sulfoxide, sulfolane, etc. Specifically, the alcohols are, for example, methanol, ethanol, propanol, etc. The esters are, for example, alkyl formates, alkyl acetates, alkyl propionate, alkyl butyrate, alkyl lactate, alkyl alkoxyacetate, alkyl 3-alkoxypropionate, alkyl 2-alkoxypropionate, alkyl 2-alkoxy-2-methylpropionate, alkyl pyruvate, alkyl acetylacetate, alkyl 2-oxobutyrate, etc. The ethers are, for example, diethylene glycol dimethyl ether, tetrahydrofuran, ethylene glycol monomethyl ether, ethylene glycol monoethyl ether, methylcellosolve acetate, ethylcellosolve acetate, diethylene glycol monomethyl ether, diethylene glycol monoethyl ether, diethylene glycol monobutyl ether, propylene glycol monomethyl ether, propylene glycol monomethyl ether acetate, propylene glycol monoethyl acetate, propylene glycol monopropyl ether acetate, etc. The ketones are, for example, methyl ethyl ketone, cyclohexanone, cyclopentanone, 2-heptanone, 3-heptanone, etc. The aromatic hydrocarbons are, for example, toluene, xylene, etc.

The mixing is, for example, stirring thoroughly at room temperature (e.g., 25° C.), such as for 4 hours or more, 6 hours or more, 8 hours or more, but not limited thereto.

In the present disclosure, the near-infrared absorption composition in the form of a dispersion can be mixed with an optical resin to form a filter lens subsequently. The ratio of the dispersion to the optical resin may be 5:1 to 1:1, or 3:1 to 1:1, such as 0.65:0.35, but not limited thereto.

The optical resin may be a thermoplastic resin and/or a photocurable resin. In an embodiment, the optical resin is selected from polycarbonates, polyesters, polycycloolefins, polyacrylics, siloxane resins and polyimides. In a further embodiment, the optical resin is a siloxane resin. In a further embodiment, the optical resin is methyl methacrylate.

In an embodiment, the near-infrared absorption composition may be further added with an initiator, such as a photoinitiator, and thereby the optical resin can be subjected to polymerization by light irradiation. A well-known initiator, including but not limited to, azodiisobutyronitrile, can be used. In an embodiment, a solvent also may be added to facilitate uniform mixing. A well-known solvent may be used as the solvent herein, including but not limited to, that mentioned herein. In an embodiment, in order to facilitate the curing process, a curing agent, such as a photocuring agent, may be further added, and thereby curing can be performed to form a film by light irradiation.

In an embodiment, other additives can be further added. For example, in order to further improve the optical properties of the filter lens, additives having the effect of reducing the transmittance of certain wavelengths, including but not limited to, additives having the effect of reducing the transmittance of near-infrared rays and ultraviolet rays, may be optionally added, wherein the effect of reducing transmittance can be achieved, e.g., by absorption, reflection, etc. In an embodiment, the additive comprises a near-infrared absorption dye and/or an ultraviolet absorption dye.

The near-infrared absorption dyes may be, for example, azo compounds, di-iminium compounds, benzene dithiol metal complexes, squaraine compounds, cyanine compounds and phthalocyanine compounds, and can adjusted the maximum absorption wavelength to be between 650 nm and 1100 nm, or more specifically between 650 nm and 750 nm. The ultraviolet absorption dyes may be, for example, azomethylene compounds, indole compounds, ketone compounds, benzimidazole compounds and triazine compounds.

In an embodiment, in order to maintain the better light transmittance, the filter lens has a haze of 0.4% or less, 0.3% or 0.2% or less, e.g., 0.4%, 0.35%, 0.3%, 0.25%, 0.2%, 0.19%, 0.18%, 0.17%, 0.16%, 0.15%, 0.14%, 0.13%, 0.12%, 0.11% or 0.1%.

The filter lens of the present disclosure has the function of filtering near-infrared rays out. The property of near-infrared absorption is affected by the thickness. In general, the cutoff capability for near-infrared rays increases as the thickness increases, but this does not satisfy the need for thinning. The cutoff capability for near-infrared rays reduces as the thickness reduces. In an embodiment, the filter lens of the present disclosure can achieve excellent cutoff capability for near-infrared rays even if its thickness is small. Specifically, the filter lens has a thickness between 25 μm and 150 μm, between 50 μm and 150 μm, or between 100 μm and 150 μm, e.g., 25 μm, 30 μm, 35 μm, 40 μm, 45 μm, 50 μm, 60 μm, 70 μm, 80 μm, 90 μm, 100 μm, 110 μm, 120 μm, 125 μm, 130 μm, 135 μm, 140 μm, 145 μm, 146 μm, 147 μm, or 150 μm.

In an embodiment, the X-ray photoelectron spectroscopy spectrum of the filter lens of the present disclosure has at least one principal peak at binding energy of 930-940 eV. In an embodiment, the at least one principal peak has counts per second of 4500 or more, 4600 or more, 4700 or more, 4800 or more, 4900 or more, or 5000 or more.

In an embodiment, for the incident light wavelength range of 930 nm to 950 nm (including for the incident light wavelength of 940 nm), the filter lens of the present disclosure has maximum transmittance of 0.1% or less, less than 0.1%, 0.05% or less, less than 0.05%, 0.01% or less, less than 0.01%, 0.005 or less, or less than 0.005%, e.g., 0.1%, 0.09%, 0.08%, 0.07%, 0.06%, 0.05%, 0.04%, 0.03%, 0.02%, 0.01%, 0.009%, 0.0008%, 0.007%, 0.0006%, 0.005%, 0.004%, 0.003%, 0.002%, 0.001%. In another aspect, for the incident light wavelength range of 930 nm to 950 nm (including for the incident light at the wavelength of 940 nm), the OD value is 3 or more, more than 3, 3.5 or more, more than 3.5, 4 or more, more than 4, 4.5 or more, or more than 4.5, e.g., 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9.

In an embodiment, for the incident light wavelength range of 830 nm to 1200 nm, the filter lens of the present disclosure has maximum transmittance of 1% or less or 0.5% or less, e.g., 1%, 0.9%, 0.8%, 0.7%, 0.6%, 0.5%, 0.4%, 0.3%, 0.2% or 0.1%; and for the incident light wavelength range of 460 nm to 560 nm, the filter lens of the present disclosure has minimum transmittance of 80% or more or 85% or more, e.g., 80%, 81%, 82%, 83%, 84%, 85%, 86%, 87%, 88%, 89% or 90%.

In an embodiment, the filter lens of the present disclosure has a passband overlaid with a wavelength range of 300 nm to 850 nm, 350 nm to 800 nm, or 350 nm to 750 nm, and the central wavelength of the passband is in the wavelength range of 300 nm to 850 nm, 300 nm to 800 nm, 350 nm to 750 nm, 400 nm to 700 nm, 450 nm to 650 nm, 500 nm to 600 nm, or 500 nm to 550 nm. Herein, “passband” refers to a range within which transmittance of 50% or more is exhibited for the incident light in the wavelength range, and “central wavelength of the passband” refers to an average value of the two incident light wavelengths corresponding to the 50% transmittance exhibited for incident light.

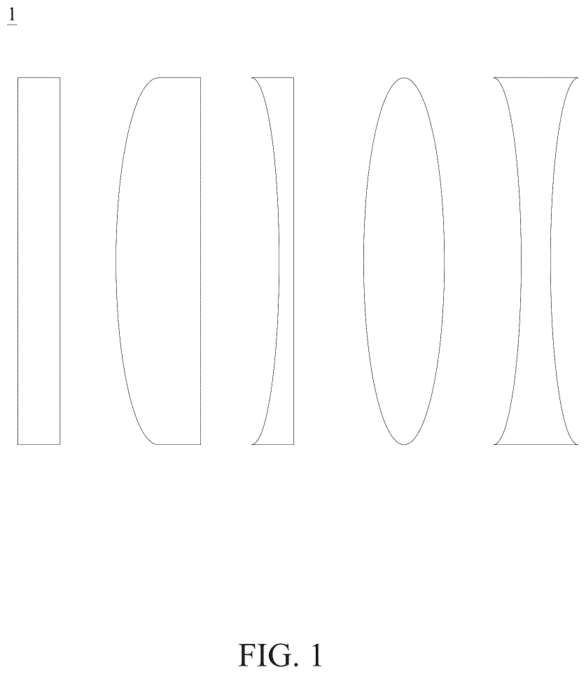

In an embodiment, the filter lens is a concave lens, a convex lens, a convex-concave lens, or a flat lens, as needed. The concave lens refers to a filter lens having a first surface and an opposite second surface, wherein at least one of the first and the second surfaces depresses inwards to form a concave surface. The convex lens is that at least one of the first and the second surfaces protrudes outwards to form a convex surface. The convex-concave lens refers to a lens in which one of the first and the second surfaces protrudes outwards to form a convex surface and the other depresses inwards to form a concave surface. The flat lens refers to one in which the first and the second surfaces are both flat surfaces. For example, the filter lenses can be those as shown in FIG. 1, in which, from right to left, are a flat lens, a flat-convex lens, a flat-concave lens, a double-convex lens, and a double-concave lens. The optical camera lens module comprises at least one lens. In general, one, two, three, four, five, six or more lenses are referred as a lens group, and the filter lens of the present disclosure can be used as one in the lens group.

The filter lens has a particular shape and particular optical properties as needed, for example, in an embodiment, the filter lens is a convex lens and further comprises an infrared absorption dye; and in an embodiment, the filter lens is a concave lens and further comprises an ultraviolet absorption dye.

The second aspect of the present disclosure provides a method for preparing a filter lens, comprising:
preparing a copper compound, a phosphonic acid represented by Formula 1, and at least one phosphor-containing compound represented by Formulas 2 to 4, and forming a composition containing a copper complex;

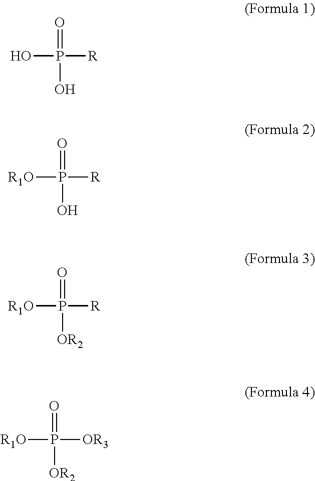

wherein R, R₁, R₂ and R₃ are each independently substituted or unsubstituted C₁-C₁₂ alkyl or C₆-C₁₂ aryl; and
curing the mixture to yield the filter lens,
wherein the OD value of the filter lens for the incident light wavelength of 930 nm to 950 nm is greater than 4.

The copper compound, the phosphonic acid, the phosphorus-containing compound involved in the second aspect are as described in the first aspect herein.

For example, for preparation of the composition, firstly, the copper compound for providing copper ions, the phosphonic acid, and the phosphorus-containing compound are prepared and mixed with a solvent to form a dispersion. The solvent is as described in the first aspect herein. The mixing herein may be performed by mixing the copper compound with the solvent firstly to form a first liquid, separately mixing the phosphorus-containing compound with the solvent to form a second liquid, and mixing the first liquid, the second liquid and the phosphonic acid to form a composition. A copper complex herein is formed in the composition due to the reaction and interaction of the components during mixing.

The composition may also comprises an optical resin. For example, after mixing the first liquid with the second liquid and further mixing with the phosphonic acid, the optical resin may be further mixed with. The optical resin is as described in the first aspect herein.

In an embodiment, the semi-product formed by mixing the first liquid with the second liquid and then with the phosphonic acid is dried into powder, and the powder is subsequently added to a second solvent, and then is mixed with an optical resin to form a composition. The second solvent can be selected from the kinds of solvents described in the first aspect herein.

In the case of adding other additives, those such as initiators, curing agents, optical property promoters having the effect of reducing transmittance of light at certain wavelengths (e.g., a near-infrared absorption dye, an ultraviolet absorption dye), etc., are added into the composition optionally. For example, the other additives may be added into the mixture before mixing with the optical resin, be added together with the mixture when mixing with the optical resin, or be added after the mixture has been mixed with the optical resin.

The method for preparing a filter lens of the present disclosure comprises a step of curing the mixture. In the present disclosure, there is no limitation on the curing process, processes should be encompassed in the scope of the present disclosure as long as through the processes the composition can be cured into a desired shape and the filter lens will have the desired optical properties.

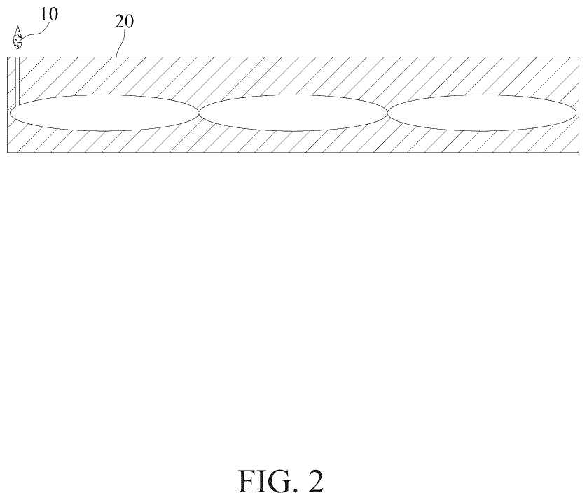

FIG. 2 is a schematic diagram of one embodiment of curing the composition of the present disclosure, wherein composition 10 is loaded into die 20 for curing-forming. Here, loading into a die for curing-forming is, e.g., injection molding, thermoforming, vacuum forming, etc. A transparent die may be used and photocuring may be carried out by loading the composition in the die and irradiating it with light. In an embodiment, the curing-forming is performed for 1 hr or less, including but not limited to, for 1 hr, 50 minutes, 45 minutes, 40 minutes, 35 minutes, 30 minutes, 20 minutes, 10 minutes, 5 minutes, 4 minutes, 3 minutes, 2 minutes, 1.5 minutes, and 1 minute.

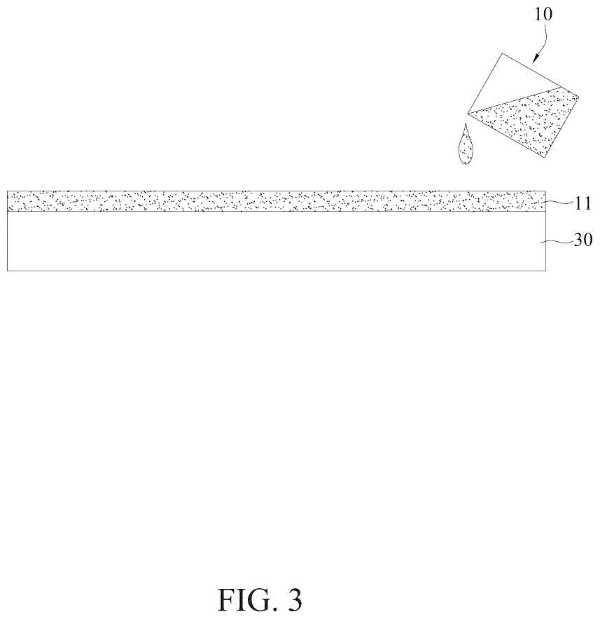

FIGS. 3-5 are schematic diagrams of another embodiment of curing the composition of the present disclosure. As shown in FIG. 3, composition 10 is coated on surface of substrate 30 to form composition layer 11. Bubbles can be removed from the mixture before coating or can be removed from the composition layer after coating. Methods for removing bubbles are without limitations, for example, bubbles may be removed by ultra-sonication, being placed in a negative pressure environment, or both concurrently. Moreover, the coating methods are also not limited, e.g., the composition may be coated by spin coating, spray coating, blade coating, roller coating, dipping, etc.

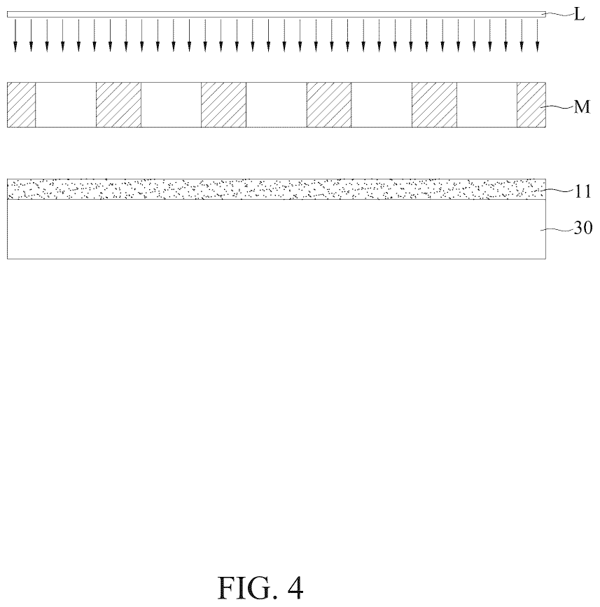

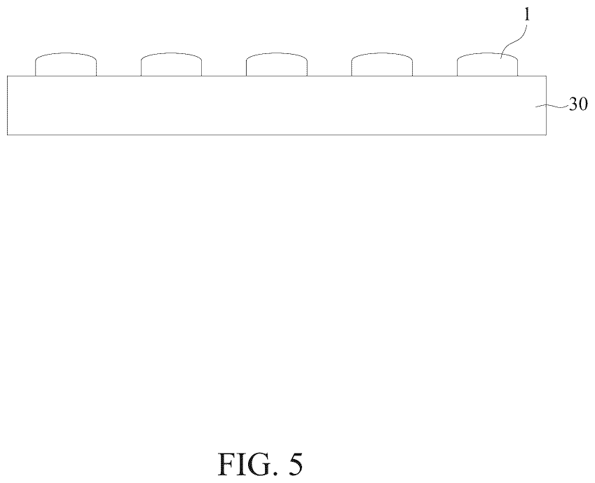

Next referring to FIG. 4, composition layer 11 is irradiated with light source L for photocuring. Mask M, such as a grayscale mask, is disposed between light source L and composition layer 11, then a lithography process is performed, which specifically allows composition layer 11 beneath mask M to be exposed selectively and cured, and thereby filter lens 1 having particular patterns or a particular shape is obtained as shown in FIG. 5. Said “having particular patterns or of a particular shape” can be achieved by designing the mask and adjusting the component of the composition as needed to form convex lenses, concave lenses or flat lenses described herein, as illustrated in FIG. 1.

In another embodiment, the composition can be coated on the substrate surface as described above, except that in this embodiment, the composition is cured directly to a film and then is subjected to a treatment to make the first and/or the second surface of the film a flat, convex or concave surface, yielding the filter lens. The treatment includes, but not limited to, etching, laser cutting, grinding, etc.

In another embodiment, the composition is dried (e.g., dried at 120° C.) to remove the solvent prior to curing.

### EXAMPLES

Further details will be described in the present disclosure by referencing to following specific Examples which are never in any sense intended to limit the scope of the present disclosure.

### Preparation Example 1

150 Weight parts of copper acetate were mixed with 15000 weight parts of ethanol and stirred at room temperature for 1.5 hrs to form a first mixture. Additionally, 20 weight parts of the phosphorus-containing compound represented by Formula 2 (plysurf A242G, purchased from Daiichi Pharmaceutical Co., Ltd.), 20 weight parts of the phosphorus-containing compound represented by Formula 3 (plysurf W542C, purchased from Daiichi Pharmaceutical Co., Ltd.,) and 50 weight parts of the phosphorus-containing compound represented by Formula 4 (plysurf A285C, purchased from Daiichi Pharmaceutical Co., Ltd.) were mixed with 1500 weight parts of ethanol to form a second mixture. The first and the second mixtures were mixed and stirred at room temperature for 1 hr and then 100 weight parts of butylphosphonic acid were added and stirred at room temperature to react for 3 hrs. Thereafter, the reaction mixture was placed in an oven at 85° C. for 12 hrs to obtain powder. The powder was mixed with xylene at a weight ratio of 1:3 to form a dispersion, the dispersion was mixed with methyl methacrylate (MMA) at a weight ratio of 0.65:0.35 to form a composition, and the composition was coated on a substrate and baked at 70° C. for 30 minutes, yielding a near-infrared absorption layer.

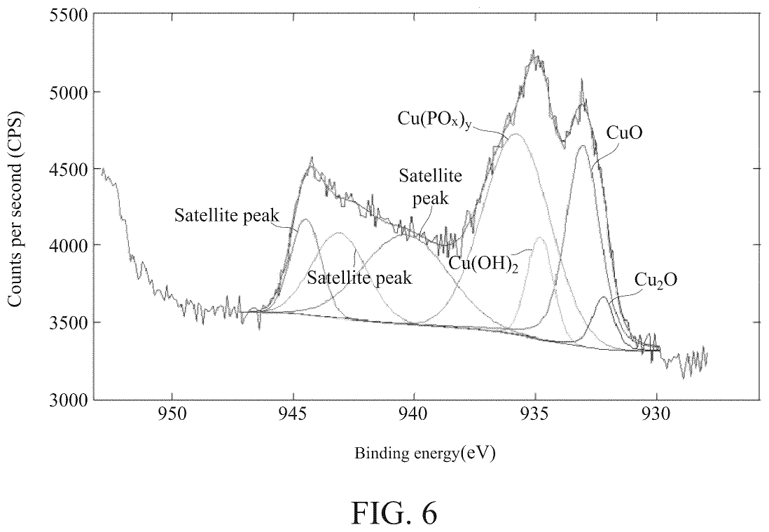

An X-ray photoelectron spectroscopy (ESCA/XPS) measurement was performed on the near-infrared absorption layer, and the X-ray photoelectron spectroscopy spectrum was shown in FIG. 6. Characteristic peaks related to the copper complex (Cu(POₓ)_{y}, CuO, Cu₂O, Cu(OH)₂) at binding energy of 930 eV to 940 eV were observed. Also, peaks occurred at binding energy of 940 eV or more were satellite peaks.

### Example 1

A dispersion and a composition were prepared according to the method of Preparation Example 1 and were subjected to ultra-sonication under a negative pressure environment for bubbles removal. The mixture was then injected into a die which has an inner cavity for forming a double-convex lens as illustrated in FIG. 2. The curing was performed at 180° C. for 1 hr, and finally, the cooling and releasing were performed to yield a double-convex filter lens.

### Example 2

A dispersion and a composition were prepared according to the method of Preparation Example 1, except that 0.5 g of azobisisobutyronitrile (AIBN) as an initiator and a suitable amount of propylene glycol methyl ether (PGME) as a solvent were added additionally. Bubbles in the composition were then removed by ultra-sonication in a negative pressure environment and the composition was spin coated onto a substrate to form a composition layer. The solvent was removed by baking at 120° C., a grayscale mask was disposed over the composition layer, and an ultraviolet light source was placed over the grayscale mask, allowing the composition layer to be patterned through selective exposure to yield a flat-convex filter lens.

The embodiments and specific examples described above are not intended to limit the present disclosure. The technical features or schemes listed can be combined with one another. The present disclosure can be implemented or applied by other different execution modes. Details recorded herein can be altered or modified differently according to different viewpoints and applications without departing from the present disclosure.

What is claimed is:

1. A filter lens, comprising:
a copper complex formed by a copper compound providing copper ions, a phosphonic acid represented by Formula 1, and at least one phosphor-containing compound represented by Formulas 2 to 4, 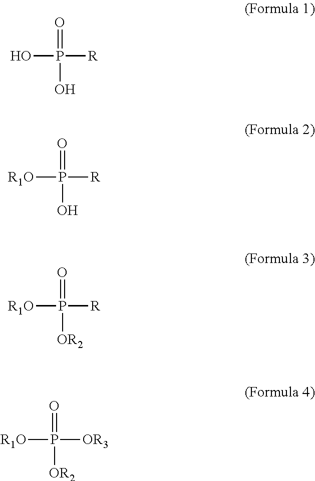
wherein R, R₁, R₂ and R₃ are each independently substituted or unsubstituted C₁-C₁₂ alkyl or C₆-C₁₂ aryl;
wherein the OD value of the filter lens for the incident light wavelength of 930 nm to 950 nm is greater than 4.

2. The filter lens of claim 1, wherein the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

3. The filter lens of claim 1, having a haze of 0.4% or less.

4. The filter lens of claim 1, wherein an X-ray photoelectron spectroscopy spectrum thereof has at least one principal peak at binding energy of 930-940 eV.

5. The filter lens of claim 4, wherein the at least one principal peak has counts per second of 4500 or more.

6. The filter lens of claim 1, having a thickness of 25-150 μm.

7. The filter lens of claim 1, further comprising an optical resin, wherein the optical resin is a thermoplastic resin and/or a photocurable resin, and the optical resin is selected from polycarbonates, polyesters, polycycloolefins, polyacrylics, siloxane resins and polyimides.

8. The filter lens of claim 7, wherein the optical resin is methyl methacrylate.

9. The filter lens of claim 1, further comprising an infrared absorption dye and/or an ultraviolet absorption dye.

10. The filter lens of claim 1, which is a concave lens, a convex lens, a convex-concave lens, or a flat lens.

11. A method for preparing a filter lens, comprising:
providing a copper compound, a phosphonic acid represented by Formula 1, and at least one phosphor-containing compound represented by Formulas 2 to 4, to form a composition containing a copper complex, 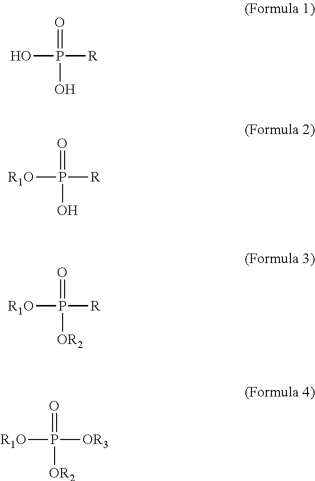
wherein R, R₁, R₂ and R₃ are each independently substituted or unsubstituted C₁-C₁₂ alkyl or C₆-C₁₂ aryl; and
curing the composition to obtain the filter lens,
wherein the OD value of the filter lens for the incident light wavelength of 930 nm to 950 nm is greater than 4.

12. The method of claim 11, wherein the curing step comprises loading the composition into a die for curing-forming to obtain the filter lens.

13. The method of claim 11, wherein the curing step comprises coating the composition on a substrate and patterning the mixture using a lithography process to obtain the filter lens.

14. The method of claim 12, wherein the curing-forming is carried out via injection molding, thermoforming, vacuum forming, or photocuring.

15. The method of claim 12, wherein the curing-forming is performed for 1 hr or less.

16. The method of claim 11, wherein the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

17. The method of claim 11, having a haze of 0.4% or less.

18. The method of claim 11, wherein an X-ray photoelectron spectroscopy spectrum thereof has at least one principal peak at binding energy of 930-940 eV.

19. The method of claim 18, wherein the at least one principal peak has counts per second 4500 or more.

20. The method of claim 11, having a thickness of 25-150 μm.

21. The method of claim 11, further comprising an optical resin, wherein the optical resin is a thermoplastic resin and/or a photocurable resin, and the optical resin is selected from the group consisting of polycarbonates, polyesters, polycycloolefins, polyacrylics, siloxane resins and polyimides.

22. The method of claim 11, wherein the optical resin is methyl methacrylate.
